(19) United States
(12) Patent Application Publication
(10) Pub. No.: US 2021/0402628 A1
(43) Pub. Date: Dec. 30, 2021

(54) SCISSORS WITH REMOVABLE FEATHER RAZOR

(71) Applicant: Kourtney Shuman, Bemus Point, NY (US)

(72) Inventor: Kourtney Shuman, Bemus Point, NY (US)

(21) Appl. No.: 16/911,588

(22) Filed: Jun. 25, 2020

(51) Int. Cl. B26B 13/24; B26B 21/12; B26B 13/20; B26B 21/40

(52) U.S. Cl. CPC B26B 13/24; B26B 21/4012; B26B 13/20; B26B 21/12

(57) ABSTRACT

A hair cutting scissors/razor device, including a static blade member and a dynamic blade member, operatively arranged to pivot relative to one another, the static blade member having a blade portion, the blade portion having a tip at a first end and a handle portion at a second end, wherein the blade portion has a cutting edge and a back edge and the handle portion has a static neck portion and a static finger ring, the static blade member also having an aperture to accommodate a tension screw, the aperture located between the first end and the second end, and closer to the first end than the second end, the blade portion having a slot therein, the slot closed proximate the tip portion, the slot arranged parallel to the cutting edge of the static blade member, the slot arranged to extend leftwardly and rightwardly of the aperture.

### FIELD OF THE INVENTION

The present invention relates to hair styling scissors to aid hair stylists in cutting and styling hair in a more efficient manner.

### BACKGROUND OF THE INVENTION

For many hair stylists, success comes not only from the quality of the work, but also from the speed at which they provide their service. The more customers a stylist or hairdresser can service in a given day, the more revenue they can earn. However, the introduction of new technology has caused hair styles to become more complex, requiring stylists to become familiar with new technologies to accommodate any requested style. This creates a problem. For a stylist to be successful, he or she must learn how to use these tools in the most efficient way possible.

One tool that has become more and more popular over the years is the feather razor. A feather razor is used to give hair more volume. It does so by layering the hair and taking away unwanted weight in the hair so that it does not lay flat to the head. Almost every hair stylist has a feather razor and uses it regularly. Depending on the style of haircut requested, the hair stylist may have to switch between his or her scissors and the feather razor countless times throughout the cut. Switching back and forth, while trying to maintain efficiency, can cause injuries to the stylist and the customer, and add unnecessary time to the service, necessarily reducing the potential revenue a stylist can earn during a single work-day.

In U.S. Pat. No. 4,805,305 a combination razor and scissor device is disclosed. A first jaw of pair of scissors comprises a recess for securing a razor. This combination device eliminates the need for a stylist to have a separate razor and pair of scissors. A problem with this particular device, however, is that the razor cartridge is inserted proximate the sharp point of the blades, risking injury. Another problem with this prior art device is that a stylist can only use the razor of the device with the scissors in an open position, which further increases the risk of injury.

Hair trimming razors are known in the art. These razors have finger rings on the rear or other portions of the handle as disclosed in U.S. Pat. No. 6,092,288. A problem with this particular device, however, is that the razor cartridge is inserted proximate the sharp point of the blades, risking injury.

U.S. Published Patent Application No. 2007/0209214 discloses a combination hair tool that comprises a scissor and a razor. The combination hair tool comprises two scissor blade portions operatively arranged to be pivotably connected, wherein one of the scissor blade portions includes a fixedly secured razorblade holder including a blade holder slot, a handle portion, and a finger ring. The combination tool razor blade scissor portion accepts a slideably secured razor blade from the opposite end of the finger ring towards the pivoting connection. A problem with this particular device, however, is that the razor cartridge is inserted proximate the sharp point of the blades, risking injury.

Thus, there is a long felt need for a pair of scissors with a removable feather razor that allows a hair stylist to cut hair with scissors and style hair with a feather razor in a single tool, safetly securing the razor, while allowing a stylist to adjust a rotatably secured finger loop. There is also a long-felt need for a pair of scissors with a removable feather razor held in a cartridge, which cartridge is installable into the scissor blade from the finger ring part of the scissors.

### SUMMARY OF THE INVENTION

The present invention broadly comprises a scissors with removable feather razor, comprising a static blade member having a blade portion, said blade portion having a tip at a first end and a handle portion at a second end, wherein said blade portion has a cutting edge and a back edge and said handle portion has a static neck portion and a static finger ring extending therefrom, said static blade member also having an aperture to accommodate a tension screw, said aperture located between said first end and said second end, and closer to said first end than said second end, said blade portion having a slot therein, said slot closed proximate said tip portion, said slot arranged parallel to said cutting edge of said static blade member, said slot arranged to extend leftwardly and rightwardly of said aperture; a dynamic blade member having a blade portion, said blade portion having a tip at a first end and a handle portion at a second end, wherein said blade portion has a cutting edge and a back edge and said handle portion has a dynamic neck portion and a dynamic finger ring extending therefrom, said dynamic blade member also having an aperture to accommodate said tension screw, said aperture located between said first end and said second end, and closer to said first end than said second end; and, a tension screw operatively arranged to pass through both said static blade aperture and said dynamic blade aperture to hold said static blade member and said dynamic blade member in close proximity to one another and form a pivot point about which both said static blade member and said dynamic blade member are operatively arranged to pivot relative to one another.

A general object of the invention is to provide an adjustable and removeable blade and scissor device that allows a stylist to use a feather razor and scissor simultaneously.

A secondary object of the invention is to provide a pair of scissors with a removeable razor blade, which blade is held in a cartridge, and which cartridge is insertable into one of the blades of the scissors from the end of the scissors closest to the finger rings.

A further object of the invention is to provide a combination scissors/feather razor blade assembly wherein the pair of scissors includes a pivot point about which the pair of scissor blades pivot, and wherein a cartridge containing the feather razor overlaps or straddles the pivot point to achieve an optimally balanced pair of scissors.

These and other objects of the invention will become apparent upon review of the following detailed description of the invention in view of the drawings and appended claims.

### BRIEF DESCRIPTION OF THE DRAWINGS

The nature and mode of the operation of the present invention will now be more fully described in the following detailed description of the invention taken with the accompanying drawing figures, in which:

FIG. 1 is a left side view of the present invention in an open position;

FIG. 2 is a right-side view of the invention in FIG. 1 in an open position showing a user holding the invention;

FIG. 3 is a left-front perspective view of the invention in FIG. 1 in an open position;

FIG. 4 is a right-front perspective view of the invention in FIG. 1 in an open position;

FIG. 5 is a left-front perspective view of the invention in FIG. 1 in a closed position;

FIG. 6 is a right-front perspective view of the invention in FIG. 1 in a closed position;

FIG. 7A is a cross-sectional view of the invention's static blade member without a removable razor cartridge in place, which view is taken generally along line 7A shown in FIG. 1;

FIG. 7B is a cross-sectional view of the invention's static blade member with a removable razor cartridge installed therein, which view is taken generally along line 7B-7B shown in FIG. 1;

FIG. 8 is a fragmentary cross-sectional view of the invention's static blade member, which view is taken generally along line 8-8 in FIG. 7A; and,

FIG. 9 is an exploded view of the invention shown in FIG. 1.

### DETAILED DESCRIPTION OF THE INVENTION

The terminology used herein is for the purpose of describing particular embodiments only and is not intended to be limiting of the invention.

As used herein, the term “and/or” includes any and all combinations of one or more of the associated listed items. As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion.

Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art, that the present invention may be practiced without these specific details.

The present disclosure is to be considered as an exemplification of the invention, and is not intended to limit the invention to the specific embodiments illustrated by the figures or description below.

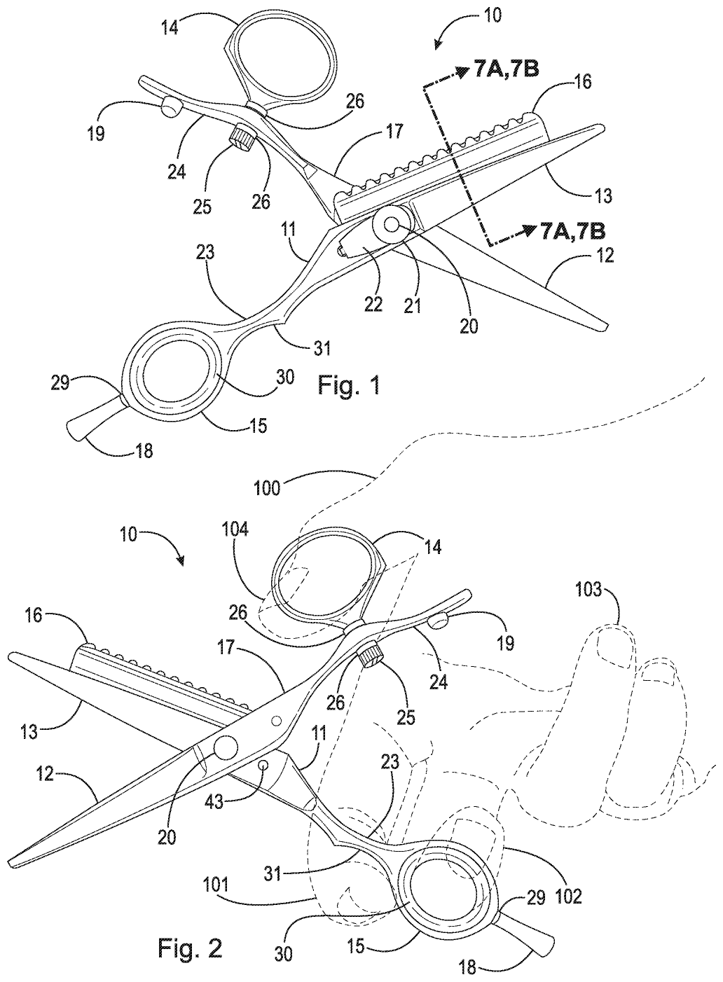

The present invention will now be described by referencing the appended figures. The following description should be read in view of FIGS. 1-6. FIG. 1 is a right-side view of the scissor and removable feather razor in an open position. Scissor razor combination 10 broadly comprises dynamic blade member 17, static blade member 11, and removeable razor cartridge 16. Dynamic blade member 17 and static blade member 11 are pivotably attached by way of tension screw 20 that is secured by lock nut 21 and tab 22, discussed further infra.

Dynamic blade member 17 further comprises dynamic blade cutting edge 12, dynamic blade member neck 24, dynamic finger ring 14, and bumper 19. Dynamic finger ring 14 is threadably secured to dynamic blade member neck 24 by finger ring tension screw and spacers 26. Bumper 19 is threadably secured to dynamic blade member neck 24.

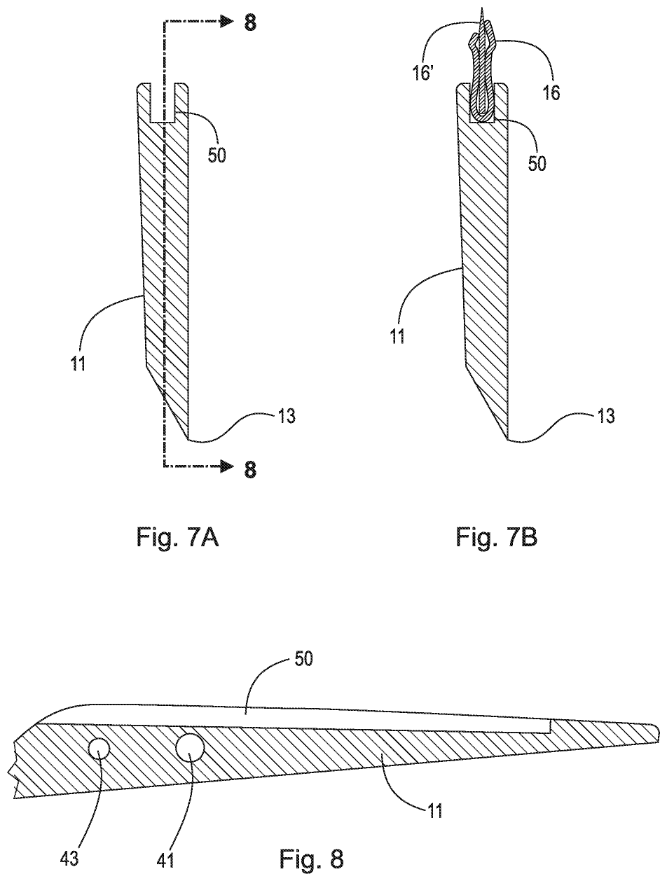

Static blade member 11 further comprises static blade cutting edge 13, static blade member neck 23, removable razor cartridge 16, static finger ring 15, finger guard 30, finger rest 18, neck finger rest 31, and slot 50 (shown in FIGS. 7A-8), discussed further infra. Finger rest 18 is threadably secured to static finger ring 15 and has finger rest washer 29 arranged on a male threaded member.

FIG. 2 is a left side view of scissor razor combination 10 with user right hand 100 holding the invention for use. FIG. 2 is further described infra.

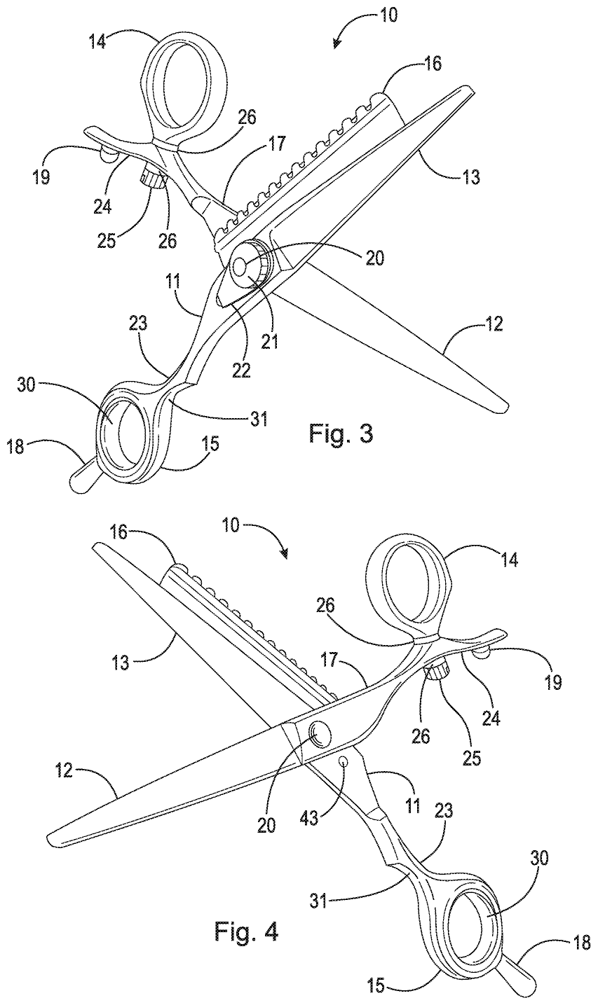

FIG. 3 is a right-front perspective view of scissor razor combination 10 in an open position.

FIG. 4 is a left-front perspective view of scissor razor combination 10 in an open position.

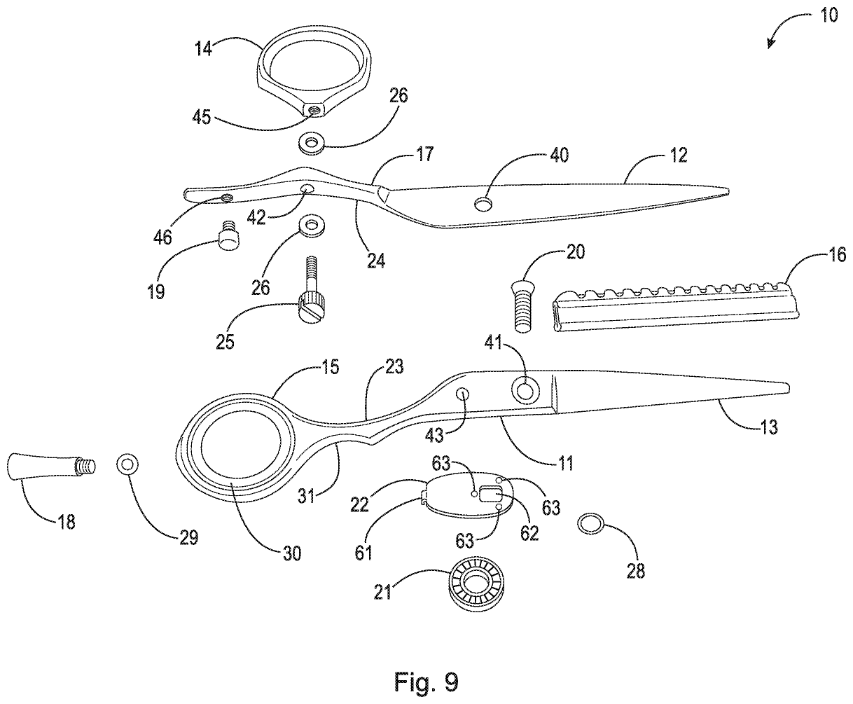

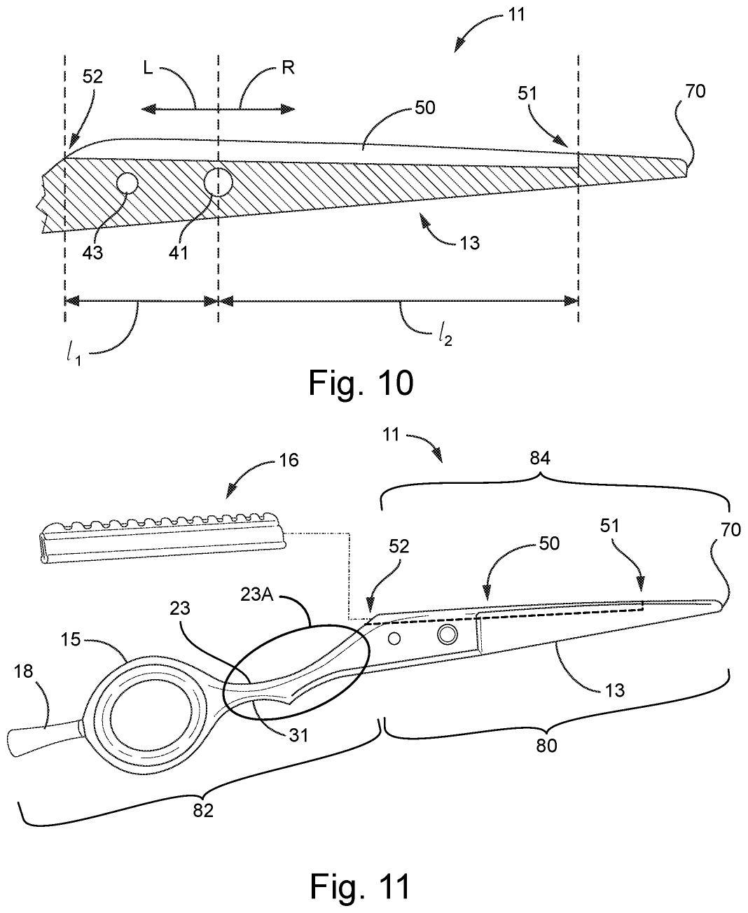

The following description should be read in view of FIGS. 3-4 and FIG. 9. Blade member tension screw 20 rotatably secures dynamic blade member 17 and static blade member 11 through substantially centered dynamic blade member aperture 40 and substantially centered static blade member aperture 41. Static blade member aperture 41 is countersunk and operatively arranged to accept cone washer 28. Tab 22 comprises tab hook 61, aperture 62, and protrusions 63. The aperture 62 of tab 22 is operatively arranged to accept tension screw 20. Tension screw 20 is secured by lock nut 21. Lock nut 21 comprises a plurality of ridges operatively arranged to contact and frictionally secure lock nut 21 to protrusions 63 on the surface of tab 22. Aperture 62 is operatively arranged to accept tab hook 61 to prevent rotation when threadably secured by tension screw 20 and lock nut 21. Tab aperture 43 may also be a depression operatively arranged to accept tab hook 61 of tab 22.

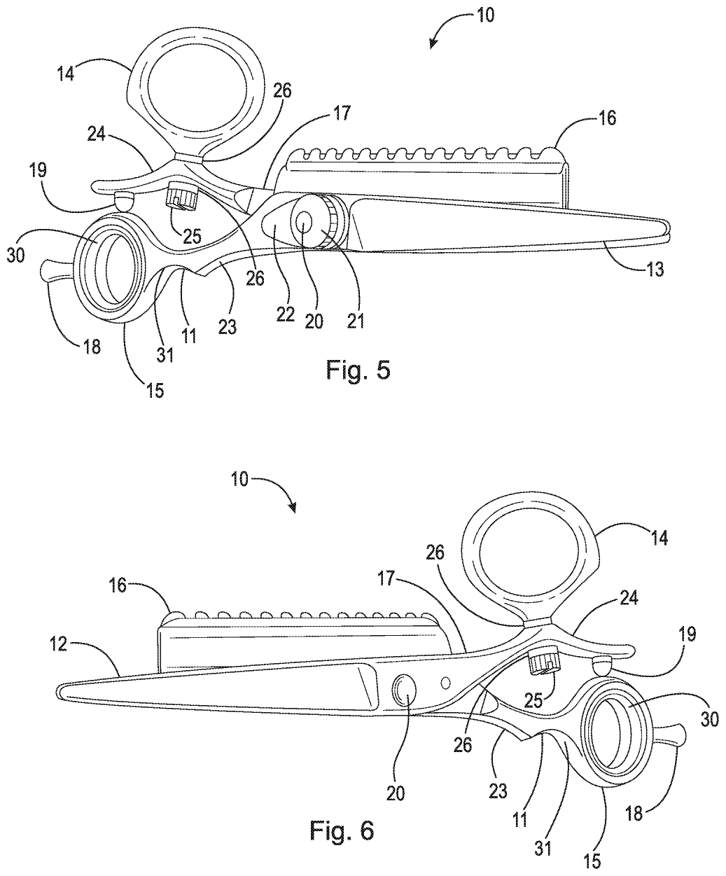

The following description should be read in view of FIG. 5 and FIG. 6. FIG. 5 is a left-front perspective view of scissor razor combination 10 in a closed position. FIG. 6 is a right-front perspective view of scissor razor combination 10 in a closed position. Bumper 19 is operatively arranged to contact outer surface of static finger ring 15. Bumper 19 prevents scissor razor combination 10 from closing further to prevent snagging hair if the respective blades were to pass the range restriction created by bumper 19. Bumper 19 also provides a user feedback as bumper contacts the surface of static finger ring 15.

Diverting to FIGS. 7A-8: FIG. 7A shows a cross-sectional front view of static blade member 11 cut along line 7A shown in FIG. 1 without removable razor cartridge 16; FIG. 7B shows a cross-sectional front view of static blade member 11 cut along line 7B shown in FIG. 1 with removable razor cartridge 16 in place in slot 50; FIG. 8 shows a partial left side view of static blade member 11 cut along line 8 shown in FIG. 7A with razor cartridge 16 removed from slot 50. The following description should be read in view of all Figures. Removable razor cartridge 16 holds razor blade 16′. Removable razor slot 50 is centrally disposed in static blade member 11 within the opposite surface of static blade member cutting edge 13. Removable razor cartridge 16 is frictionally secured within removable razor slot 50 by outwardly pushing edges that contact the inner surfaces of removable razor slot 50. Removable razor slot 50 terminates before the tip of static blade member 11 as shown in FIG. 8. Removable razor cartridge 16 substantially straddles the pivot point at tension screw 20 at dynamic blade aperture 40 and static blade aperture 41. Removable razor cartridge 16 is slideably inserted into removable razor slot 50 towards static blade member neck 23 end towards static blade member cutting edge 13. Removable razor slot 50 extends in length in a direction opposite of the tip of static blade member 11. The length of removable razor slot 50, in the direction opposite static blade member 11 tip and in the direction of tab aperture 43, is shorter than the length of removable razor slot 50 that extends in the direction of static blade member 11 towards the tip, relative to static blade member aperture 41, as illustrated in FIG. 8.

Diverting back to FIG. 2; FIG. 2 shows scissor razor combination 10 held in right hand 100. Dynamic finger ring 14 is operatively arranged to access thumb 104 to hold dynamic blade member 17. Dynamic finger ring 14 is rotatably adjustable to accommodate thumb 104 resting within to the most ideal and comfortable position for a user, reducing fatigue that fixed thumb rings may cause. Static finger ring 15 is operatively arranged to accept middle finger 102. Static finger ring comprises inner finger guard 30 to protect middle finger 102 from sustained use, reducing fatigue from continual use. Neck finger rest 31 is operatively arranged to provide a contoured and ergonomic surface for index finger 101 to rest. Static blade member 11 also includes finger rest 18 that is operatively arranged to optionally allow ring finger 103 to also rest thereon, further improving comfort for a user over prolonged use.

To use removable razor 16, scissor razor combination 10 is moved to a closed position shown in FIGS. 5 and 6. A user would comb a section or layer of hair and pull removable razor 16 up or down that section or layer to create a textured or feathered look.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMBERS

10 scissor/razor combination
11 static blade member
12 dynamic blade cutting edge
13 static blade cutting edge
14 dynamic finger ring
15 static finger ring
16′ razor blade
16 removable razor cartridge
17 dynamic blade member
18 finger rest
19 threaded bumper
20 blade member tension screw
21 lock nut
22 tab
23 static blade member neck
24 dynamic blade member neck
25 finger ring tension screw
26 spacer
28 cone washer
29 finger rest washer
30 finger guard
31 neck finger rest
40 dynamic blade member aperture
41 static blade member aperture
42 finger ring aperture
43 tab aperture
44 finger rest aperture
45 threaded bumper aperture
46 threaded finger ring aperture
50 slot
61 tab hook
62 aperture
63 frictional bumps

1. A scissors with removable razor cartridge, comprising:
a static blade member having a blade portion, said blade portion having a tip at a first end and a handle portion at a second end, wherein said blade portion has a cutting edge and a back edge and said handle portion has a static neck portion and a static finger ring extending therefrom, said back edge extending from said tip and terminating at said static neck portion, said blade portion also having an aperture to accommodate a tension screw, said aperture located between said first end and said second end, and closer to said first end than said second end, said blade portion having a slot arranged within said back edge thereof, said slot closed proximate said tip and open proximate said neck portion and arranged to extend leftwardly and rightwardly of said aperture, said slot arranged to releasably hold a removable razor cartridge;
a dynamic blade member having a blade portion, said blade portion having a tip at a first end and a handle portion at a second end, wherein said blade portion has a cutting edge and a back edge and said handle portion has a dynamic neck portion and a dynamic finger ring extending therefrom, said blade portion also having an aperture to accommodate said tension screw, said aperture located between said first end of said dynamic blade member and said second end of said dynamic blade member, and closer to said first end than said second end; and,
a tension screw operatively arranged to pass through both said aperture of said static blade member and said aperture of said dynamic blade member to hold said static blade member and said dynamic blade member in close proximity to one another and form a pivot point about which both said static blade member and said dynamic blade member are operatively arranged to pivot relative to one another.

2. The scissors with removable razor cartridge recited in claim 1 wherein said static neck portion of said static blade member includes a finger rest extending outwardly from said finger ring of said static blade member.

3. The scissors with removable razor cartridge recited in claim 1 wherein said dynamic finger ring is operatively arranged to swivel.

4. The scissors with removable razor cartridge recited in claim 1, wherein said removable razor cartridge is arranged to hold a razor blade.

5. The scissors with removable razor cartridge recited in claim 1 wherein said dynamic blade member further comprises a cutting edge and a neck.

6. The scissors with removable razor cartridge recited in claim 1 wherein said static blade member further comprises a cutting edge and a neck.

7. The scissors with removable razor cartridge recited in claim 1, wherein said dynamic blade member and said static blade member are made of steel.

8. The scissors with removable razor cartridge recited in claim 1, wherein said dynamic blade member and said static blade member are made of aluminum.

9. The scissors with removable razor cartridge recited in claim 1, wherein said static blade member and said dynamic member are rotatably secured by said tension screw and a lock nut, wherein said tab is sandwiched between said lock nut and said static blade member when said lock nut is engaged to said tension screw.

10. The scissors with removable razor cartridge in claim 9 wherein said tab further comprises:
a hook;
a plurality of frictional bumps;
a tab aperture centrally arranged on said tab, wherein said tab aperture is operatively arranged to accept said tension screw; and,
said hook is operatively arranged to fit within a hook aperture, said hook aperture is arranged adjacent to said aperture of said blade portion of said static blade member.

11. The scissors with removable razor cartridge recited in claim 1 further comprising a rubber guard, operatively arranged about an inner surface of said finger ring on said static blade member.

12. The scissors with removable razor cartridge recited in claim 1 wherein said dynamic neck portion comprises a bumper threadably secured thereto, wherein said bumper is operatively arranged to contact said static finger ring of said static blade member during use.

13. A static blade member for a scissors with removable razor cartridge, said static blade member comprising a blade portion, said blade portion having a back edge extending from a tip of said blade portion to a neck portion of said static blade member, said neck portion arranged opposite of said tip; and, a slot arranged on said back edge, said slot having an open end and a closed end, said open end of said slot is arranged proximate to said neck portion, said closed end of said slot is arranged proximate to said tip of said blade portion, wherein said slot is arranged to accept a removable razor cartridge at said open end, said slot further arranged to releasably hold said removable razor cartridge therein.

14. The static blade member for a scissors with removable razor cartridge recited in claim 13, wherein said blade portion of said static blade member further comprises an aperture thereon, said aperture arranged proximate to said neck portion, wherein said slot is further arranged to extend a first length relative to said aperture towards said open end, said slot is arranged to extend a second length relative to said aperture towards said closed end, and said second length of said slot is greater than said first length of said slot.

15. A scissors having the static blade member recited in claim 14, said scissors further comprising a dynamic blade member having a blade portion, said blade portion having an aperture arranged thereon, said dynamic blade member having a neck extending from said blade portion arranged oppositely from a tip of said blade portion, and said neck having a dynamic finger ring rotatably secured thereon, wherein said aperture of said static blade member and said aperture of dynamic blade member are arranged to accept a tension screw, said tension screw further arranged to rotatably secure said dynamic blade member and said static blade member.
